(19) United States
(12) Patent Application Publication
(10) Pub. No.: US 2011/0070019 A1
(43) Pub. Date: Mar. 24, 2011

(54) JOINT

(75) Inventors: SHANG-XUAN SONG, Shenzhen City (CN); CHENG ZHANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/691,869

(22) Filed: Jan. 22, 2010

(30) Foreign Application Priority Data
Sep. 22, 2009 (CN) 200910307456.1

(51) Int. Cl. F16B 1/00; F16B 7/18

(52) U.S. Cl. 403/26; 403/220; 403/408.1

(57) ABSTRACT

A joint includes a first retaining base, a connecting rod, a positioning plate, and at least two elastic members. The connecting rod is movably connected to the first retaining base. The positioning plate is fixed to the connecting rod. The at least two elastic members are disposed between the first retaining base and the positioning plate. The at least two elastic members are arranged along a circumference of the connecting rod.

### BACKGROUND

1. Technical Field

The present disclosure relates generally to joints, especially to a joint rotatable through multiple axes.

2. Description of Related Art

Industrial robots are widely used in various applications to increase efficiency. A manipulator is an important component of the industrial robot. A typical manipulator includes a mechanical arm and an actuator connected to the mechanical arm. The actuator engages a workpiece.

However, a frequent problem occurs wherein the actuator cannot move freely relative to the mechanical arm. While a typical joint is often applied to interconnect the mechanical arm and the actuator, it can be difficult to resume the original position.

Therefore, a joint which overcomes the described limitations is desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an assembled, isometric view of an embodiment of a joint.

FIG. 2 is an exploded view of the joint of FIG. 1.

FIG. 3 is a cross-section of the joint taken along line III-III of FIG. 1.

FIG. 4 is a cross-section of the joint taken along line IV-IV of FIG. 1.

### DETAILED DESCRIPTION

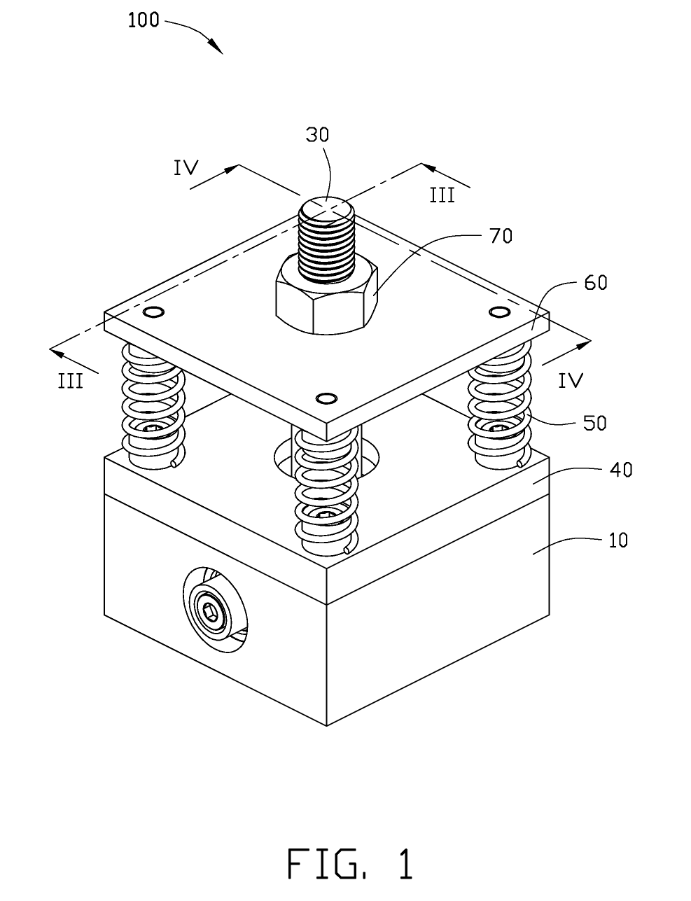

Referring to FIG. 1, an embodiment of a joint 100 includes a first retaining base 10, a connecting rod 30, four elastic members 50, and a positioning plate 60. The connecting rod 30 is movably connected to the first retaining base 10 at an end of connecting rod 30. The positioning plate 60 is fixed to the connecting rod 30 away from the first retaining base 10. The four elastic members 50 are disposed between the first retaining base 10 and the positioning plate 60.

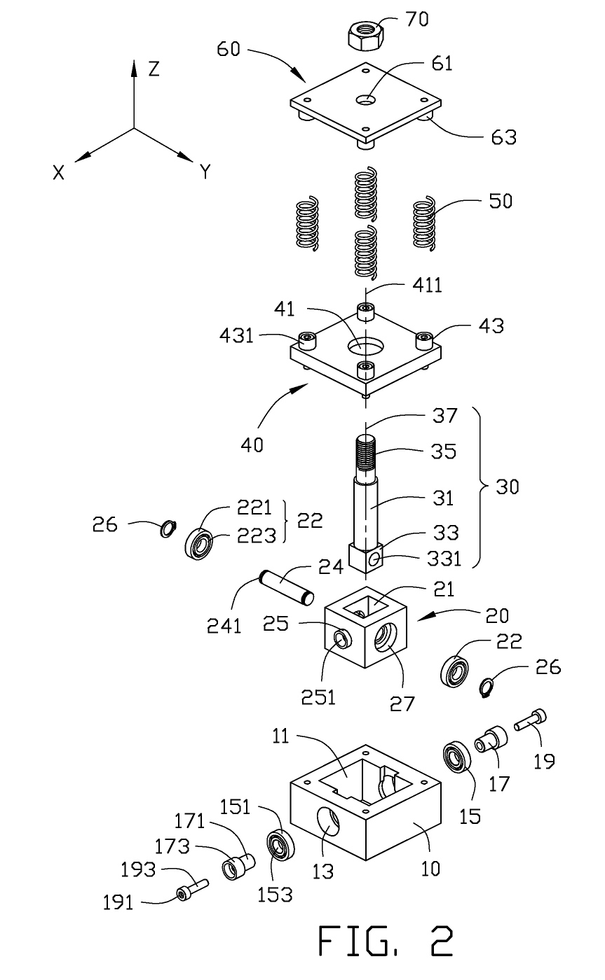

Referring to FIG. 2, the first retaining base 10 may be substantially rectangular, thereby defining a substantially rectangular cavity 11 in the middle portion thereof. Two pivot holes 13 are further defined on the opposite side surfaces of the first retaining base 10, and communicating the cavity 11. The two pivot holes 13 are aligned parallel to the X-axis as shown in FIG. 2.

The joint 100 further includes two first bearings 15, two bushings 17, and two first pivots 19. The first bearing 15 includes an outer bearing ring 151 located inside the pivot hole 13 and an inner bearing ring 153 sleeved by the outer bearing ring 151. The outer bearing ring 151 is fitted inside the pivot hole 13. The bushing 17 includes a cylindrical latching portion 171 and a receiving portion 173 connected to the latching portion 171. The latching portion 171 has approximately the same diameter as a through hole of the inner bearing ring 153, thus the latching portion 171 can be correspondingly fixed into the inner bearing ring 153. The first pivot 19 extends in a direction parallel to the X-axis, and is substantially cylindrical in shape. The first pivot 19 includes a head portion 191 received in the receiving portion 173 of the bushing 17 and a threaded portion 193 connected to the head portion 191. The threaded portion 193 passes through the bushing 17, the inner bearing ring 153 of the bearing 15, the pivot hole 13, and finally enters the cavity 11. The first bearing 15 may, for example, be designed as an anti-friction bearing, such as a needle or ball bearing. In the illustrated embodiment, the bearing 15 is a ball bearing.

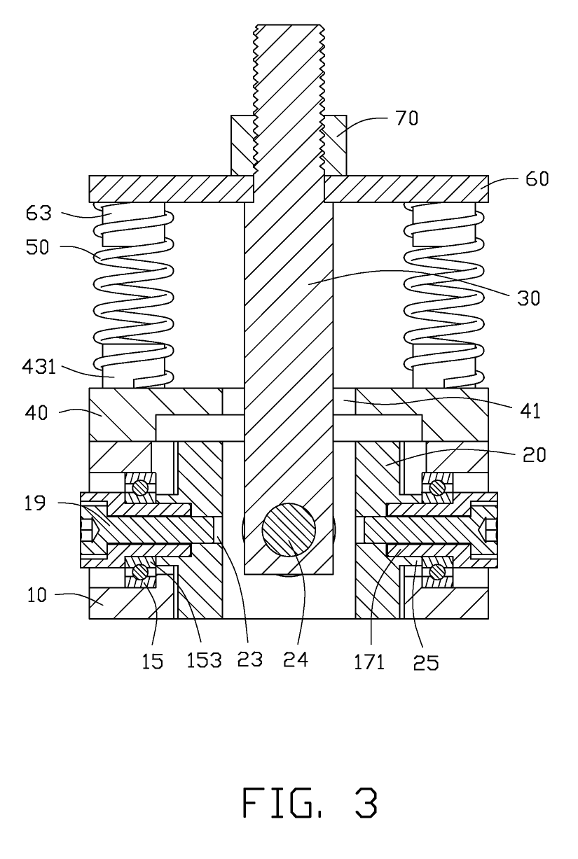

The joint 100 further includes a substantially rectangular rocking piece 20 received inside the cavity 11. A width of the rocking piece 20 is smaller than that of the cavity 11 along the Y-axis. The rocking piece 20 defines a substantially rectangular receiving groove 21 to receive an end of the connecting rod 30. The rocking piece 20 further defines two threaded holes 23 (shown in FIG. 3) on opposite side surfaces of the rocking piece 20 communicating the receiving groove 21. The two threaded holes 23 are aligned parallel to the X-axis; and each thread hole 23 receive each of the threaded portions 193 of the first pivots 19. The rocking piece 20 includes two cylindrical supporting portions 25 extending outwardly from two side surfaces of the rocking piece 20 adjacent to the two threaded holes 23. The supporting portion 25 and the side surface of rocking piece 20 cooperatively define a receiving groove 251 to receive the latching portion 171 of the bushing 17. The rocking piece 20 further defines two pivot holes 27 aligned parallel to the Y-axis on opposite side surfaces of the rocking piece 20 communicating the receiving groove 21.

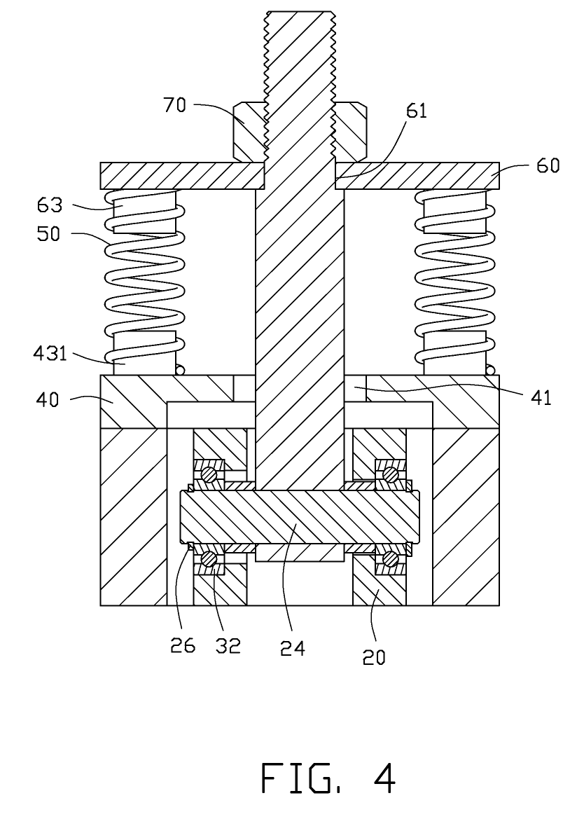

Referring to FIGS. 2 and 4, the joint 100 further includes two second bearings 22, a second pivot 24, and two securing members 26. The second bearing 22 is the same as the first bearing 15, and includes an outer bearing ring 221 located inside the pivot hole 27 and an inner bearing ring 223 sleeved by the outer bearing ring 221. The second pivot 24 is substantially cylindrical and extends in a direction parallel to the Y-axis. The second pivot 24 has approximately the same diameter as the inner bearing ring 223, thus the two ends of the second pivot 24 can be correspondingly fixed into the corresponding two inner bearing rings 223. The second pivot 24 defines two latching grooves 241 adjacent to each end of the second pivot 24. The two securing members 26 are received in the corresponding latching grooves 241 to secure the bearing 22 on the second pivot 24. In the illustrated embodiment, the securing member 26 is a pivot securing ring.

The connecting rod 30 includes a substantially cylindrical main body 31, and a substantially rectangular pivoting portion 33 and a threaded portion 35 extending from the opposite end of the main body 31. The pivoting portion 33 is narrower than the receiving groove 21 of the rocking piece 20 along the X-axis. The pivoting portion 33 defines a pivot hole 331 to receive the second pivot 24. The pivot hole 331 has approximately the same diameter as the second pivot 24, thus the second pivot 24 can be correspondingly fixed into the pivoting portion 33. The connecting rod 30 has a center axis 37 along its extending direction.

The joint 100 further includes a covering plate 40. The covering plate 40 may be substantially square, and defines a substantially circular through hole 41 in a middle portion to receive the main body 31 of the connecting rod 30. A diameter or width of the through hole 41 exceeds that of the main body 31, thereby allowing the main body 31 to move freely in the through hole 41 accordingly. It is to be understood that, the shape of the through hole 41 can vary, as long as the width of the through hole 41 exceeds that of the main body 31. The through hole 41 defines a center axis 411. The joint 100 further includes four fastening members 43 disposed on four corners of the covering plate 40. In other words, two pairs of fastening members 43 are positioned symmetrically about the axis 411 of the through hole 41. The covering plate 40 is fixed to the first retaining base 10 via the four fastening members 43. In the illustrated embodiment, the fastening member 43 is a bolt, and includes a cylindrical head portion 431.

The positioning plate 60 has a shape similar to the covering plate 40, and defines a substantially circular positioning hole 61 to receive the threaded portion 35 of the connecting rod 30 in a middle portion of the position plate 60. The positioning hole 61 has approximately the same diameter as the threaded portion 35. The joint 100 further includes four guide bars 63 positioned on a surface of the positioning plate 60 facing the covering plate 40. The four guide bars 63 are disposed at four corners of the positioning plate 60 according to the four head portions 431.

One end of each elastic member 50 sleeves the head portion 431 of the fastening member 43, and the other end of each elastic member 50 sleeves the guiding bar 63. In the illustrated embodiment, the elastic member 50 is a spring.

The joint 100 further includes a nut 70 threaded on the threaded portion 35 of the connecting rod 30, and the nut 70 is resisting the positioning plate 60.

Referring to FIGS. 1-4, during assembly, the pivoting portion 33 of the connecting rod 30 is positioned inside the receiving groove 21 of the rocking piece 20, and the pivot hole 331 of the pivoting portion 33 is aligned with the pivot hole 27. The second pivot 24 passes through the pivot hole 27 of the rocking piece 20 and the pivot hole 331 of the pivoting portion 33. Two bearings 22 are sleeved at two ends of the second pivot 24 and are located inside the two pivot holes 27, respectively. Accordingly, the connecting rod 30 is pivotally connected to the rocking piece 20 via the second pivot 24, and is rotatable relative to an axis of the second pivot 24 in the receiving groove 21. The threaded portion 35 of the connecting rod 30 is capable of moving through a plane defined by the X-axis and the Z-axis shown in the FIG. 2 because the pivoting portion 33 is narrower than the receiving groove 21 of the rocking piece 20. The two second fastening members 26 are received in the corresponding latching grooves 241 of the second pivot 24, respectively, such that the two bearings 22 are secured on the second pivot 24.

The rocking piece 20 is positioned inside the cavity 11; and the receiving groove 251 is aligned with the pivot hole 13 of the first retaining base 10. The first bearing 15 is fixed inside the pivot hole 13. The latching portion 171 of the bushing 17 passes through the inner bearing ring 153 of the first bearing 15, the pivot hole 13, and is finally positioned inside the receiving groove 251. The threaded portion 193 of the first pivot 19 passes through the bushing 17, and engages in the threaded hole 23 of the rocking piece 20, such that the bushing 17 is fixed to the rocking piece 20, and the head portion 191 is received in the receiving portion 173 of the bushing 17. Accordingly, the rocking piece 20 is pivotally connected to the first retaining base 10 via the first pivot 19, which is substantially perpendicular to the second pivot 24. The rocking piece 20 is rotatable relative to an axis of the first pivot 19 in the cavity 11 because the rocking piece 20 is narrower than that of the cavity 11, such that the connecting rod 30 is capable of moving through a plane defined by the Y-axis and the Z-axis shown in the FIG. 2.

The covering plate 40 is fixed to the first retaining base 10 via the four fastening members 43, after the threaded portion 35 of the connecting rod 30 passes through the through hole 41 of the covering plate 40. In a normal starting state, the axis 411 of the through hole 41 and the axis 37 of the connecting rod 30 cooperate. The four elastic members 50 are sleeved on the four corresponding head portions 431 of the fastening members 43, such that the four elastic members 50 are positioned along a circumference of the connecting rod 30. The positioning plate 60 is positioned on the four elastic members 50, and four guide bars 63 are sleeved in the corresponding four elastic members 43, respectively. The nut 70 is threaded on the threaded portion 35 of the connecting rod 30, such that the positioning plate 60 is fixed to the connecting rod 30.

During use, the first retaining base 10 may be fixed to a manipulator (not shown) by some means of fasteners, such as bolts, and the connecting rod 30 may be connected to a polishing device (not shown). When polishing various workpieces, the connecting rod 30 may receive a torque to rock freely relative to the first retaining base 10. The rotational torque can be attributed to one through a plane defined along the Y-Z axis and another through a plane defined along the X-Z axis, thereby providing movement to the rocking piece 20 relative to the axis of the first pivot 19 and relative to the axis of the second pivot 24, thereby allowing the connecting rod 30 to perform rocking movements with respect to the first retaining base 10. In a normal state, the four elastic members 50 impel the positioning plate 60 in a direction parallel to the Z-axis towards the nut 70. However, when the connecting rod 30 starts to move, the positioning plate 60 may also move along the X-axis and/or the Y-axis a certain distance with respect to the starting location, whereby at least one of the four elastic members 50 is compressed, and the other elastic members 50 are stretched. These compressed and stretched elastic members 50 will provide a resilient force to the positioning plate 60 when the workpieces stop inputting torque to the connecting rod 30, thereby impelling the connecting rod 30 to move or lean backward, and finally return to its normal state automatically.

The four elastic members 50 can provide a relatively resilient force to normalize the torque of the connecting rod 30 due to the arrangement of the four elastic members 50. The resilient force of the four elastic members 50 can be adjusted by adjusting the position of the nut 70 relative to the connecting rod 30. In addition, even when an elastic member 50 ages and fails to function, the other elastic members 50 can still provide a sufficient amount of resilient force applied to the connecting rod 30, thus the joint 100 has a relatively longer lifetime. Furthermore, the connecting rod 30 moves easily because the first and second bearings 15, 22 are in the form of anti-friction ball bearings.

The connecting rod 30 may be movably connected to the first retaining base 10 in other ways. For example, in an alternative embodiment, one end of the connecting rod 30 may be spherical, whereby the first retaining base 10 defines a spherical cavity receiving the spherical end of the connecting rod 30.

It is to be understood that the covering plate 40 may be omitted as long as the four elastic members 50 are fixed to the first retaining base 10 directly. It should also be noted that the configurations of the elastic members 50 are not limited to the embodiments described above. The quantity and positions of the elastic members 50 are specifically described and illustrated for the purpose of exemplifying various aspects of the present joint 100.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A joint, comprising:
a first retaining base;
a connecting rod movably connected to the first retaining base;
a positioning plate fixed to the connecting rod; and
at least two elastic members disposed between the first retaining base and the positioning plate, wherein the at least two elastic members are arranged along a circumference of the connecting rod.

2. The joint of claim 1, wherein the at least two elastic members are positioned symmetrically about an axis of the connecting rod.

3. The joint of claim 1, further comprising a covering plate fixed to the first retaining base, and the covering plate defining a through hole to receive the connecting rod, wherein a width of the through hole exceeds the width of the connecting rod.

4. The joint of claim 3, further comprising at least two fastening members symmetrically positioned on the cover plate relative to an axis of the through hole; and the cover plate is fixed to the first retaining base via the at least two fastening members.

5. The joint of claim 4, further comprising at least two guide bars positioned on a surface of the positioning plate facing the covering plate; wherein each of the at least two elastic members is fixed to the corresponding guide bar.

6. The joint of claim 1, wherein the positioning plate defines a positioning hole to receive the connecting rod; the connecting rod comprises a threaded portion adjacent to an end thereof; and the joint further comprises a nut threaded on the threaded portion of the connecting rod to fix the connecting rod to the positioning plate.

7. The joint of claim 1, further comprising a rocking piece and a first pivot; the rocking piece is pivotally connected to the first retaining base via the first pivot, and the rocking piece is connected to the connecting rod and is rotatable relative to an axis of the first pivot.

8. The joint of claim 7, wherein the first retaining base defines a cavity to receive the rocking piece; the cavity has a larger width than the rocking piece.

9. The joint of claim 7, further comprising a bushing, and the bushing sleeving the first pivot, and the first retaining base defining a pivot hole therein to receive the bushing.

10. The joint of claim 9, further comprising a first bearing located inside the pivot hole, and the bushing comprising a latching portion fixed into the first bearing.

11. The joint of claim 10, wherein the rocking piece defines a receiving groove therein to receive the latching portion.

12. The joint of claim 10, wherein the first bearing is a ball bearing.

13. The joint of claim 7, further comprising a second pivot by which the connecting rod is pivotally connected to the rocking piece, and the connecting rod is rotatable relative to an axis of the second pivot; and the second pivot is substantially perpendicular to the first pivot.

14. The joint of claim 13, wherein the connecting rod comprises a pivoting portion connecting to the second pivot; the rocking piece defines a receiving groove to receive the pivoting portion; and the receiving groove is wider than the pivoting portion.

15. The joint of claim 13, wherein the rocking piece defines a pivot hole therein to receive the second pivot.

16. The joint of claim 15, further comprising a second bearing located inside the pivot hole of the rocking piece, and the second bearing is sleeved on the second pivot.

17. The joint of claim 16, wherein the second bearing is a ball bearing.
